(19) United States
(12) Patent Application Publication
(10) Pub. No.: US 2004/0088582 A1
(43) Pub. Date: May 6, 2004

(54) Data network-based system

(76) Inventors: Torbjorn Hovmark, Vallentuna (SE); Lars Resenius, Aladdinsvagen 4 (SE)

Correspondence Address: Nixon & Vanderhye, 8th Floor, 1100 North Glebe Road, Arlington, VA, 22201-4714, US

(21) Appl. No.: 10/432,541

(22) PCT Filed: Nov. 26, 2001
(86) PCT No.: PCT/SE01/02611

(30) Foreign Application Priority Data
Nov. 24, 2000 (SE) 0004338-0

(51) Int. Cl. H04L 9/00

(52) U.S. Cl. 713/201; 713/168

(57) ABSTRACT

The invention relates to a data network-based system (1′) which is adapted for data communication and which includes a number of users (2) belong-ing to a first category and a number of users (3) belonging to a second category. A first user (2) belonging to the first category is adapted to use a chosen security protocol (20, 21) to establish a secure session with a second user (3) belonging to said second category, and subsequent to positive authentication allow data com-munication to pass through a firewall (6). A means (8) pre-coupled to the firewall (6) is adapted to establish the identity of the first user through the medium of a handshake procedure (21) belonging to the security protocol (20), and to allow messages to be forwarded from the first user to the second user belonging to said secure session in response to accepted authentication.

### FIELD OF INVENTION

The present invention relates generally to a data network-based system, and more particularly to a data network-based system that is adapted for identity-based and authenticated data communication between chosen users.

The invention is based on a system, which, in respect of such data communication, includes a number of users belonging to a first user category and a number of users belonging to a second user category.

A first user belonging to said first category wishing to communicate with a second user belonging to said second category can be offered passage through a firewall only after secure and accepted authentication has been obtained.

The present invention has been devised with the intention of obtaining beneficial application when the first category user is a WAP user and the second category user consists of computer equipment, such as a company-associated web server, and where the data network used is comprised totally or partially of the Internet.

### DESCRIPTION OF THE BACKGROUND ART

Systems based on data networks for communication between selected users of the kind described more generally in the introduction are known to the art.

Two prior art systems that form a basis for the present invention will be described in more detail below with reference to FIGS. 1 and 2, where FIG. 1 illustrates a WAP user who wishes to communicate with a translator, a WAP gateway, in order to connect with a company-associated web server via a data network, such as the Internet.

FIG. 2 shows that a WAP user can establish direct connection with a company-associated web server via a data network, such as the Internet.

It is also known to adapt a first user belonging to the first category to use a chosen security protocol in order to establish a secure session with a second user belonging to said second category.

### SUMMARY OF THE PRESENT INVENTION

Technical Problems

When taking into consideration the technical deliberations that a person skilled in this particular art must undertake in order to provide a solution to one or more technical problems, it will be seen that on the one hand it is necessary initially to realise the measures and/or the sequence of measures that must be undertaken, and on the other hand to realise which means is/are required to solve one or more of said problems. On this basis, it will be evident that the technical problems listed below are highly relevant to the development of the present invention.

When considering the present state of the art as described above, e.g. in respect of the earlier known systems, such as the systems illustrated schematically in FIGS. 1 and 2, it will be seen that a technical problem resides in creating, with the aid of simple means, conditions in which each user belonging to said first category is able to pass through a firewall set up by the second user for data communication between said first and second users, after said second user has established the requisite authentication.

It will also be seen that a technical problem resides in realising the significance of and the advantages afforded by pre-coupling one such firewall with a means that functions as a “sentinel”.

Another technical problem is one of realising the significance of enabling said means to establish authentication with respect to the first user via a chosen large portion of a handshake procedure.

A further technical problem resides in realising the significance of and the advantages afforded by allowing messages from the first user belonging to said security session to be forwarded to the second user via said pre-coupled means when authentication has been accepted.

Another technical problem resides in realising the significance of and the advantages afforded by providing a data communication system that has the aforesaid facilities, in which the first user may be a WAP user.

Another technical problem is one of realising the significance of and the advantages afforded by providing a data communications system in which the second user may be computer equipment, such as a company-related web server.

Another technical problem is one of realising the significance of and the advantages afforded by enabling a chosen large part of a handshake procedure to be switched between the first user and said means prior to allowing the first user access to the second user.

Another technical problem resides in realising the significance of and the advantages afforded by allowing the means to forward to the second user all messages earlier received from the first user only when accepted authentication has been established, and allowing the first user access to the second user at the same time.

Still another technical problem resides in realising the significance of and the advantages that are afforded when the pre-coupled means is adapted to forward said messages to the second user through said firewall.

Another technical problem resides in realising the significance of and the advantages that are afforded when the firewall is configured so that said means and said second user can freely communicate through the firewall.

Another technical problem is one of realising the significance of and the advantages associated with locating said means within a firewall-related demilitarised zone.

Yet another technical problem is one of realising the significance of and the advantages afforded by authenticating said first user by means of a client certificate, in the presently proposed application.

Another technical problem is one of realising the significance of and the advantages that are afforded when authentication of said first user is effected by using a one-time password.

A technical problem also resides in realising the significance of and the advantages that are gained when said security protocol is comprised of one of a number of accessible protocols, such as a WTLS protocol, or an SSL protocol, or a TLS protocol, or an IP-Sec protocol,

Solution

The present invention thus takes as its starting point a system based on a data network adapted for data communication, wherein said system includes a number of users belonging to a first category and a number of users belonging to a second category, wherein a first user belonging to said first category is adapted to use a selected security protocol for establishing a security session with a second user belonging to said second category, and subsequent to secure authentication allow information to pass through a firewall.

In order to solve one or more of the aforesaid technical problems, it is now proposed in accordance with the invention that there is used a means which is pre-coupled to the firewall and which is adapted to establish a first-user identity, via a handshake procedure belonging to said security protocol, and that said means pre-coupled to the second user allows messages from the first user belonging to said secure session to be forwarded.

In accordance with preferred embodiments that lie within the scope of the present invention, it is proposed that the first user may well be a WAP user, whereas the second user may well be computer equipment, such as a web server.

It is also proposed in accordance with the invention that a chosen large portion of a handshake procedure shall be switched between the first user and said means and that the means shall send to the second user messages earlier received from the first user upon receiving accepted authentication, and that the second user thereafter finalises the handshake procedure with said first user. It is also proposed in accordance with the invention that the firewall shall be configured so that said means and said second user are able to communicate freely through said firewall.

It is preferred that said means is located within a firewall-related demilitarised zone.

It is also proposed that authentication of said first user is conveniently achieved by means of a client certificate.

According to one preferred embodiment, authentication of said first user is achieved with the use of a one-time password.

It is also proposed that the security protocol may be one of a number of accessible protocols, primarily a WTLS protocol. Alternatively, there may be used to this end an SSL protocol, or a TLS protocol, alternatively an IP-Sec protocol.

Advantages

Those advantages primarily achieved by an inventive system reside in the provision of conditions, which enable a system-related first user with which access to the second user has been accepted to establish a secure session with said second user by authenticating the first user with a standard security protocol through through the medium of a means located outside a firewall.

As a result, conditions and provisions have been created that make it impossible for the first user to send information to the second user without authentication having been established via the means pre-coupled to the firewall.

The primary characteristic features of a system based on a data network and adapted for data communication in accordance with the present invention are set forth in the characterising clause of the accompanying claim 1.

### BRIEF DESCRIPTION OF THE DRAWINGS

Two known systems based on data networks and adapted for data communication will now be described together with an inventive system with reference to the accompanying drawing, in which

FIG. 1 illustrates a first known system based on a data network and adapted for data communication;

FIG. 2 illustrates a second known system based on a data network and adapted for data communication;

FIG. 3 illustrates the principles of an inventive system based on a data network and adapted for data communication;

FIG. 4 illustrates the principles of a handshake procedure chosen from a number of available handshake procedures, and data communication based on the use of a sentinel means in accordance with the invention; and

FIG. 5 is a block diagram illustrating schematically the means according to the invention.

### DESCRIPTION OF EARLIER KNOWN SYSTEMS

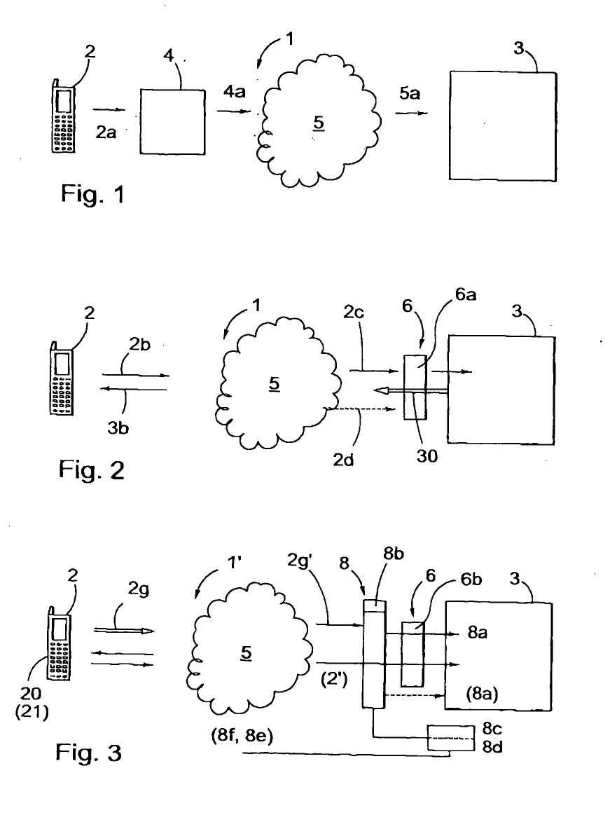

FIG. 1 illustrates a system 1 which is based on a data network and adapted for data communication, wherein said system includes a number of users 2 belonging to a first category, in the illustrated case WAP users, and a number of users 3 belonging to a second category, in the illustrated case computer equipment exemplified as a company-related web server.

The system illustrated in FIG. 1 utilises an operator-related translator, a WAP gateway 4, and a data network 5, in the illustrated case the Internet.

It is known when using such a system for data communication, to use encryption for the exchange of information in such data communication.

It will thus be apparent that the transmission of data established via a communications channel 2a may be encrypted in accordance with a first protocol, whereas data communication via channels 4a, 5a may be encrypted in accordance with the same protocol as that applicable to the channel 2a, although said communication may alternatively be encrypted in accordance with other protocols.

One drawback with the system shown in FIG. 1 is that it is necessary for the information transmitted to pass through the translator 4, where the encryption protocol applicable to incoming information transmissions may be changed to another encryption protocol applicable to the transmission of information to and via the Internet 5.

This means that the second user 3 cannot be certain of the encryption protocol that has been used in respect of the channel 2a, and neither can said second user be certain of the identity of the first user.

However, it is possible to evade this drawback by allowing the first user 2, according to FIG. 2, to use a channel 2b that is connected directly to Internet 5 and therewith be able to co-act directly with the second user 3, wherewith the same encryption protocol is used between user 2 and user 3.

FIG. 2 is also intended to illustrate the use of a firewall 6 by a user 3 in order to limit the data information received solely to user-related data information that is accepted by the second user.

This is made possible by creating “holes” 6a in the firewall 6.

In this regard, the firewall is configured by administrators tied to the user or the company 3, wherewith the administrators create clear address-related holes through which exchanges of information can take place.

Each of the users 2 shown in FIG. 2 that has access to information relating to an address-related hole can thus establish an exchange of information with the user 3.

This is normally achieved by the user 2 sending via the Internet 5 an address-related message 2b, which passes through the hole 6a and arrives at the user 3 as message 2c.

The user 3 can, in turn, send a message 3a to the user 2 through the firewall 6, via the Internet 5, this message being received as message 3b.

A message 2d that does not carry a hole-related address cannot therefore pass through the firewall 6.

### DESCRIPTION OF EMBODIMENTS AT PRESENT PREFERRED

FIG. 3 shows a complementary addition of the earlier known system 1 shown in FIG. 2, in accordance with the inventive principles.

A common feature of the two systems 1, 1′ is found in the use and participation of a first user 2, a data network in the form of the Internet 5, a firewall 6, and a second user 3.

The two systems 1, 1′ differ from one another by virtue of a means 8 that functions as a “sentinel”.

The present invention is based on a system 1′ which is based on a data network and adapted for data communication, said system including a number of users 2 belonging to a first category and a number of users 3 belonging to a second category, wherein a first user 2 belonging to the first category is adapted to use a chosen security protocol 20 for establishing a secure session with a user 3 belonging to the second category, and to provide passage through the firewall 6 subsequent to secure authentication.

The means 8 pre-coupled to the firewall 6 is thus adapted to establish a first user identity via a handshake procedure 21 belonging to the security protocol 20 and upon receipt of accepted authentication allows messages to be forwarded from the first user 2 to the second user 3 belonging to said secure session.

The means 8 has a function 8b with which a handshake and security protocol from among a number of accessible handshake and security protocols is made accessible for the exchange of signals between the user 2 and the means 8.

Similar to the known technology, the first user 2 may be a WAP user, while the second user 3 may be computer equipment 3, such as a company-related web server.

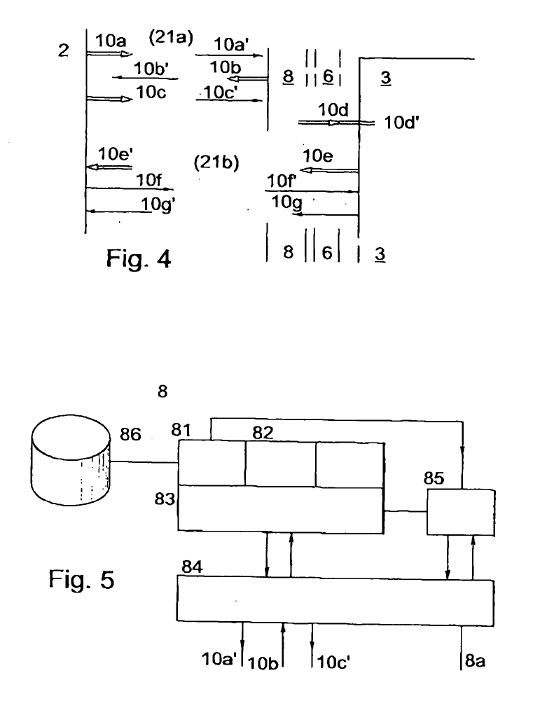

It is particularly proposed in accordance with the invention that a chosen portion 21a of said handshake procedure 21 is exchanged between the first user 2 and the means 8, as will be evident from a chosen example illustrated in FIG. 4.

When there is obtained in the means 8 an accepted authentication (2′) based on a portion 21a of the handshake procedure 21 used, the means 8 sends to the second user 3 messages 8a earlier received from the first user 2, and the second user 3 thereafter finalises the handshake procedure 21 with said first user 2, via a terminating portion 21b of said procedure.

The pre-coupled means 8 may conveniently be adapted to allow these messages 8a to be forwarded to the second user 3 through a hole 6a in the firewall 6.

It is also advised that the firewall 6 may be configured so that said means 8 and said second user 3 are able to communicate freely through the firewall 6.

The means 8 is located in a firewall-related demilitarised zone.

Requisite authentication of the first user 2 can be achieved by using a client certificate or, in accordance with an alternative embodiment, with the use of a one-time password.

It is also proposed that the security protocol used may be a security protocol chosen from a number of accessible security protocols. In this regard, a WTLS protocol is primarily proposed or, in accordance with alternative embodiments, an SSL protocol or a TLS protocol, alternatively an IP-Sec protocol.

More generally, as shown in FIG. 3, each initiation of a desired data communication from the first user 2 to the second user 3 takes place by the first user 2 making a call to the second user 3 via a channel 2g and the Internet 5, said call 2g′ being inputted to the means 8.

As will be seen more clearly from FIG. 5, the means 8 is provided in a known manner with circuits, etc., that function to establish the identity of the first user 2, through the medium of computer software and via a selected portion of the handshake procedure, and thereafter assign to the second user 3 the task of finalising the handshake procedure and therewith establish a secure session.

The means 8 will then participate in the communication procedure by forwarding the messages belonging to the established security session and sent from the first user 2 to the second user 3 and forwarding the messages from the second user 3 to the first user 2 respectively.

FIG. 4 is a schematic illustration of a chosen handshake procedure.

Different handshake procedures may be used in the present context. For the sake of simplicity, however, a standard WTLS protocol has been described.

Thus, in the FIG. 4 illustration, the first user 2 sends a first message 10a (via the channel 2g in FIG. 3) that is received in the means 8 in the form of a message 10a′.

The means 8 now sends back a message 10b, which is received in the first user 2 in the form of message 10b′.

The user 2 now sends a further message 10c, which is received by the means 8 as a message 10c′.

In the case of a WTLS protocol, the message sequence will have the following appearance in the case of the proposed embodiment:

| | | |
|---|---|---|
| First user 2 | Means 8 | Second user 3 |
| ClientHello (10a) | → (10a′) | |
| | ServerHello | |
| | Certificate | |
| | CertificateRequest | |
| (10b′) [symbol] | (10b) ServerHelloDone | |
| Certificate | | |
| ClientKeyExchange | | |
| CertificateVerify | | |
| ChangeCipherSpec | | |
| Finished (10c) | → (10c′) | |
| | (10d) → | (10d′) |
| | | ChangeCipherSpec |

| | | |
|---|---|---|
| (10e′) | [symbol] | (10e) Finished |
| Application Data | | |
| (10f) → | | (10f″) |

| | | |
|---|---|---|
| (10g′) | [symbol] | (10g) Application Data |

Subsequent to the means 8 having received the message (10c′) and having verified and accepted the certificate belonging to the first user 2, all earlier exchange messages are sent in a message (10d), which is received by the second user 3 in the form of a message here referenced (10d′).

The second user 3 then terminates the handshake procedure, by sending the message (10e) to the first user 2 via the means 8.

The secure session is then established and the first user 2 and the second user 3 are able to exchange encrypted messages (10f), (10f′) and (10g), (10g′) via the means 8.

FIG. 5 is a block diagram of the means 8.

The means 8 includes a handshake protocol 81, an alert protocol 82, a record protocol 83, a transport protocol 84, a communications protocol 85, and a database 86.

The database 86 may typically include CA certificates, client certificates, a list over invalid certificates, and so on.

The invention also includes a computer program product 8c, which includes a computer program code 8d that executes the functions assigned to a to means 8 when the code is executed by a computer unit 8e.

The invention also includes a computer readable and/or a data carrying medium 8f, where said computer program code 8d is stored in said computer readable medium.

It will be understood that the invention is not restricted to the aforedescribed exemplifying embodiment thereof and that modifications can be carried out within the scope of the inventive concept as illustrated in the accompanying claims.

1. A data network-based system adapted for data communication and comprising a number of users belonging to a first category and a number of users belonging to a second category, wherein a first user, belonging to a first category, is adapted to use a chosen security protocol for establishing a secure session with a second user, belonging to a second category, and after positive authentication to allow data communication passage through a firewall, characterized in that a means pre-coupled to said firewall is adapted to establish the identity of the first user through the medium of a handshake procedure belonging to said security protocol and in response to authentication accepted by said means to forward messages, belonging to said secure session, from the first user to the second user.

2. A system according to claim 1, characterized in that the first user is a WAP user.

3. A system according to claim 1 or 2, characterized in that said second user is a piece of computer equipment, such as a company-owned web server.

4. A system according to claim 1, 2 or 3, characterized in that a portion of said handshake procedure is exchanged between the first user and said means; in that the means sends to the second user in response to accepted authentication messages received from the first user; and in that the second user is adapted to then finalise said handshake procedure with the first user.

5. A system according to any one of the preceding claims, characterized in that the pre-coupled means is adapted to allow messages to be forwarded to the second user through the firewall.

6. A system according to any one of the preceding claims, characterized in that the firewall is configured to enable said means and said second user to communicate freely through the firewall.

7. A system according to any one of the preceding claims, characterized in that said means is located in a firewall-related demilitarised zone.

8. A system according to any one of the preceding claims, characterized in that authentication of said first user is effected by using a client certificate.

9. A system according to any one of claims 1-7, characterized in that authentication of said first user is effected by using a one-time password.

10. A system according to any one of the preceding claims, characterized in that said security protocol is selected from a number of accessible security protocols.

11. A system according to any one of the preceding claims, characterized in that the security protocol is a WTLS protocol.

12. A system according to any one of claims 1-9, characterized in that said security protocol is an SSL protocol or a TLS protocol.

13. A system according to any one of claims 1-9, characterized in that said security protocol is an IP-Sec protocol.

14. A computer program product, characterized in that said product includes a computer program code which, when executed by a computer unit, performs the functions assigned to a means according to any one of claims 1 to 13.

15. A computer readable medium, characterized in that said medium includes a computer program product in which a computer program code according to claim 14 is stored.

16. A computer program product according to claim 14, characterized in that the product includes a computer program code which, when executed by a computer which is user-accessible and is adapted to carry out the stages concerning user communication with a means.

17. A carrier medium, characterized in that said medium carries a computer program code required in accordance with one or more of claims 14 or 16.
